(19) United States
(12) Patent Application Publication
(10) Pub. No.: US 2017/0057800 A1
(43) Pub. Date: Mar. 2, 2017

(54) METHOD AND APPARATUS FOR ASSISTED HEAT TRANSFER FOR CONTAINERS

(71) Applicant: Stokely-Van Camp, Inc., Chicago, IL (US)

(72) Inventors: Michael F. McGOWAN, Indianapolis, IN (US); Rei-Young Amos WU, Palatine, IL (US)

(21) Appl. No.: 15/247,571

(22) Filed: Aug. 25, 2016

Related U.S. Application Data
(60) Provisional application No. 62/379,004, filed on Aug. 24, 2016.
(60) Provisional application No. 62/210,287, filed on Aug. 26, 2015.

(51) Int. Cl. B67C 3/22; B65C 3/26; B67C 7/00; B65D 1/02; B65D 41/32

(52) U.S. Cl. CPC B67C 3/22; B65D 1/02; B65D 41/325; B67C 7/0006; B67C 7/0073; B65C 3/26; B67C 2003/226

(57) ABSTRACT

A method and apparatus for assisting the cooling or heating of product, such as beverages, in a container can include agitating the contents of the container to create movement and to generate eddy currents in the contents. The method and apparatus can help to reduce the temperature gradients in the contents and to increase the heat transfer rate of the contents while simultaneously cooling or heating the contents and simultaneously transporting the containers. The containers can be cooled or heated using a cooling or heating media, in a cooling or heating tunnel, or in a reservoir. Agitating the contents of the container can be accomplished with a vibration generator, which can be selected from a pulsating fluid, a shaker, a motor rotating an unbalanced mass, a tactile transducer, an acoustic device, and a subwoofer. The vibration generator can be a pulsating fluid that is also a cooling or heating media.

### CROSS-REFERENCE TO RELATED APPLICATIONS

This application claims filing priority rights with respect to currently pending U.S. provisional patent application Ser. No. 62/379,004 entitled “Method and Apparatus for Assisted Heat Transfer for Container” filed Aug. 24, 2016, and U.S. provisional patent application Ser. No. 62/210,287 entitled “Method and Apparatus for Assisted Heat Transfer for Container” filed on Aug. 26, 2015, which are incorporated by reference in their entirety as illustrative examples.

### BACKGROUND

Technical Field

The present invention relates to a method and apparatus for assisting heat transfer in a container. This can be accomplished by causing movement, for example, micro eddy currents, in the contents of a container, thereby reducing a temperature gradient in the contents and increasing a heat transfer rate for the contents. As additional examples, the present invention relates to using a vibration generator, for example, a pulsating fluid, a shaker, a motor rotating an unbalanced mass, a tactile transducer, or a subwoofer, to cause movement, deformation, or vibration of a container wall, thereby causing movement in the contents of the container.

Background

In a hot fill bottling process, product to be placed into a container, which can be formed of a suitable plastic, e.g., PET, can be heated for sterilization purposes. Specifically, the heating of the product to be placed into the container helps to sterilize the product prior to being poured into the container and also can help to prevent the growth of microorganisms inside the container after filling to assist in improving the shelf life of the product. During a hot fill process, often the containers are filled while the liquid is in the temperature range of 175° F. to 185° F. (79.44° C. to 85.00° C.). Many products are suitable for hot filling, for example, high-acid products with a pH of less than 4.5. These exemplary products can include, among others, sports drinks, fruit juices, vegetable juices, or flavored water.

Contrastingly, bottles can also be filled using a cold-fill process. Cold-fill temperatures are those that fall below the hot-fill temperature range. In particular, some cold fill techniques utilize temperatures just above freezing, at room temperature, or significantly higher ranging from above 32° F. to 160° F. (0.00° C. to 71.11° C.). In certain examples, cold filling can be used for milk and various other dairy items, sparkling waters, wines, beers, and juices. In manufacturing juices, cold filling and pasteurization can be combined and can be used in connection with refrigerated distribution and storage. Cold filled juices sold in a refrigerated state can be packaged, for example, in plastic bottles or gable-top cartons. Certain cold filled and hot filled products must also be refrigerated to ensure adequate shelf life.

After the hot filling bottling process, or in certain cold-fill applications, the bottled contents must be cooled before certain operations. For example, in some instances if the container is too hot, the labeler, which applies a label to the containers, would not run efficiently if the container temperature is above a specific temperature, for example 110° F. (43.33° C.). Bottling operations often have to heat the containers after the filling process so that the labels adhere properly to the containers. In addition, product quality can be compromised if it is held at an elevated temperature for a prolonged period of time.

Nevertheless, container cooling can, in some instances, be a slow energy removal step. For example, in some processes, the operation can take approximately 20 minutes and can require long cooling tunnels to bring the temperature down considerably. For example, the contents of the containers can have to be cooled 70° F. (21.11° C.), from, e.g., 180° F. to 110° F. (82.22° C. to 43.33° C.), for particular labelers to run properly.

Conversely, certain cold-filled beverages, for example, that are filled under refrigeration, can need to be heated for labeling to reach a temperature at which the labeler will operate properly. In addition, in certain climates, additional heating can be needed to reach the requisite labeling temperature.

In warmer climates or during warmer seasons, manufacturing facilities can need to utilize water for the cooling processes, which can, in certain instances, add additional costs to cool the contents of the containers to the appropriate temperature. In certain manufacturing processes, it can be beneficial to increase the heat transfer process to help in reducing the size of the cooling equipment. Accelerating the heat transfer process can also help in reducing the amount of energy and water usage and clean-in-place (“CIP”) chemicals.

### SUMMARY

This Summary provides an introduction to some general concepts relating to this disclosure in a simplified form that are further described below in the Detailed Description. This Summary is not intended to identify key features or essential features of the disclosure.

In a first aspect, the invention provides a method for producing a liquid product comprising several steps. A first step, comprises filling a plurality of containers with the liquid product. A second step comprises capping each of the containers with an enclosure. A third step comprises agitating the liquid product of the containers to mix the liquid product in the containers to create movement of the liquid product within the containers and to generate eddy currents, reducing a temperature gradient in the liquid product to increase a heat transfer rate of the liquid product in the containers, while simultaneously cooling or heating the liquid product of the containers.

In a second aspect, the invention provides a method comprising several steps. A first step comprises causing movement in a portion of a wall of a container relative to a remainder of the wall of the container to agitate contents of the container to mix the contents in the container to create movement of the contents within the container and to generate eddy currents in the contents, reducing a temperature gradient in the container to increase a heat transfer rate of the contents in the container. A second step comprises, simultaneously cooling or heating the contents of the container.

In a third aspect, the invention provides an apparatus comprising several elements. A first element comprises a cooling or heating medium. A second element comprises a vibration generator configured to agitate contents of a container to mix the contents in the container to create movement of the contents within the container and to generate eddy currents in the contents, reducing a temperature gradient in the contents of the container to increase a heat transfer rate of the contents in the container while the cooling or heating medium is applied to the container.

Additionally, aspects of the disclosure relate to methods and apparatuses for assisting or accelerating the heat transfer for bottled beverage containers. Improving the overall heat transfer rate for container cooling or heating can help to minimize the equipment needed for container cooling or heating. For example, the temperature of the containers can need to be either decreased or increased after filling such that the temperature of the container is suitable for other processing, such as labeling or packaging.

An example apparatus can include one or more of: a conveyor belt for transporting containers, a cooling or heating medium, and a vibration generator configured to agitate contents of the containers to mix the contents in the containers to create movement of the contents within the containers and to generate eddy currents in the contents, reducing temperature gradients in the container to increase a heat transfer rate (or accelerate the heat transfer) of the contents in the containers.

An example method can include one or more of: conveying containers through a system, applying a cooling or heating medium to the containers, agitating the contents of the containers to mix the contents in the containers to create movement of the contents within the containers and to generate eddy currents in the contents, reducing temperature gradients in the container to increase a heat transfer rate of the contents in the containers.

Other aspects, embodiments and features of the invention will become apparent from the following detailed description of the invention when considered in conjunction with the accompanying drawings. The accompanying figures are schematic and are not intended to be drawn to scale. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The novel features believed characteristic of the invention are set forth in the appended claims. The invention itself, however, as well as a preferred mode of use, further objectives and advantages thereof, and the foregoing Summary, will be better understood by referenced to the following Detailed Description of illustrative embodiments when considered in conjunction with the accompanying drawings in which like reference numerals refer to the same or similar elements in all of the various views in which that reference number appears. Exemplary embodiments of the disclosure will now be described by way of example only and with reference to the accompanying drawings, in which:

FIG. 1 depicts an example process for filling and packaging containers.

FIG. 2 depicts a schematic illustration of an example apparatus and method for cooling or heating contents of containers.

FIG. 3 depicts a schematic illustration of another example apparatus and method for cooling or heating contents of containers.

FIG. 4 depicts a schematic illustration of another example apparatus and method for cooling or heating contents of containers.

FIG. 5 depicts a schematic illustration of another example apparatus and method for cooling or heating contents of containers using a nozzle that can be oriented in various directions.

FIG. 6 depicts a schematic illustration of another example apparatus and method for cooling or heating contents of containers using a plurality of nozzles that can be provided in a pattern approximating the surface of a sphere or some portion thereof.

FIG. 7 depicts a schematic illustration of a cooling/heating tunnel for cooling or heating the contents of containers.

FIG. 8 depicts a schematic illustration of movement of a portion of a wall of a container relative to a remainder of the wall of the container to create eddy currents in the contents of the container.

### DETAILED DESCRIPTION

In the following description of various example structures in accordance with the disclosure, reference is made to the accompanying drawings, which form a part hereof, and in which are shown by way of illustration of various structures in accordance with this disclosure. Additionally, it is to be understood that other specific arrangements of parts and structures can be utilized, and structural and functional modifications can be made without departing from the scope of the present disclosure. Also, while the terms “top,” “bottom,” “upper,” “lower,” “rear,” “front,” and the like can be used in this specification to describe various example features and elements of the invention, these terms are used herein as a matter of convenience, e.g., based on the example orientations shown in the figures and/or the orientations in typical use. Nothing in this specification should be construed as requiring a specific three dimensional or spatial orientation of structures in order to fall within the scope of this invention. Moreover, the figures of this disclosure can represent the scale and/or dimensions according to one or more embodiments, and as such contribute to the teaching of such dimensional scaling. However, those skilled in the art will readily appreciate that the disclosure herein is not limited to the scales, dimensions, proportions, and/or orientations shown in the figures.

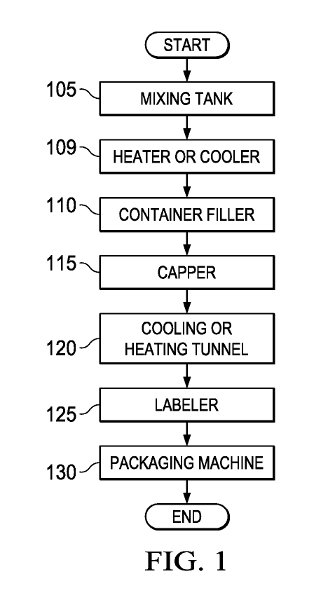

Referring to FIG. 1, an example flow chart of a manufacturing line for producing and packaging a beverage is shown. The manufacturing line can include a mixing tank or chamber 105, a heat exchanger, heater or cooler 109 (in which the heater can also be a sterilizer), a container filler 110, a capper 115, a cooling/heating tunnel 120, a labeler 125, and a packaging machine 130. However, the manufacturing line can include other equipment, and the equipment of the manufacturing line can be arranged in a different order than is shown in FIG. 1, equipment can be omitted, equipment can be substituted for the listed equipment to provide a similar function, or some combination thereof.

An example method for producing a beverage utilizing the manufacturing line of FIG. 1 is also described in relation to FIG. 1. First, the desired contents of the product can be mixed together to form the beverage in the mixing tank 105. For example, raw ingredients, such as juices, water, flavorings, colorings, and/or vitamin fortified ingredients can be emptied in the mixing chamber 105 and can be mixed together to produce the desired beverage.

After the beverage is formed in the mixing chamber 105, it can then be heated or cooled to the desired temperature for filling. For example, the product can be heated for sterilization purposes (e.g. using heater or cooler 109). The product can be sterilized (e.g., with the heater) whether the product is a hot-filled sport beverage (e.g., Gatorade®) or a cold-filled carbonated beverage (e.g., Pepsi®). Additionally, the product can be heated for a hot fill bottling process as discussed herein. In one particular example of a sterilization process, the liquid can be heated to a temperature range of 175° F. to 185° F. (79.44° C. to 85.00° C.). The liquid can be heated to the same temperature range for a hot fill process so that there is no need to further cool down the beverage before filling when using a hot fill process. Alternatively, the beverage can be prepared for a cold fill process, as discussed herein, where the product is heated or cooled as necessary to, for example, just above freezing, room temperature, or significantly higher than room temperature. The temperatures at which the beverage can be heated or cooled to for the cold fill process can, in certain examples, are less than 175° F. (79.44° C). or range from above 32° F. to 160° F. (0.00° C. to 71.11° C.) or between 32° F. to 175° F. (0.00° C. to 79.44° C.).

After the beverage is prepared for the desired type of fill process, the beverage can then be dispensed into individual containers at the container filler 110. Next, the individual containers are transferred to the capper 115, where the containers are sealed with enclosures 203 (e.g., caps, etc.).

The product, in most instances, will then need to be cooled or heated to the appropriate temperature for labeling the container at the labeler 125. After the containers are sealed at the capper 115, the containers can be either cooled or heated in the cooling/heating tunnel 120. In this example, a cooling/heating tunnel 120, as will be described in additional detail below, can be provided to cool or heat the contents in the containers to the appropriate temperature for labeling at the labeler 125. In the cooling/heating tunnel 120, the contents of the containers can be agitated, mixing the contents of the containers to create movement of the beverage within the containers and to generate eddy currents. This process helps to reduce the temperature gradients in the beverages within the containers and to increase the heat transfer rate of the beverage in the containers while simultaneously cooling or heating the contents of the containers in the cooling/heating tunnel 120 and simultaneously transporting the containers.

Examples of eddy currents include a rotating (e.g., swirling) current of fluid and an opposite current of the fluid that are created as the fluid flows past an object in its path or along or against a container wall. Accordingly, an example of an eddy current is a relatively smaller eddy current (e.g., micro eddy current) that occurs in the confined space of a container (e.g., bottle) as opposed, for example, in a river or the open ocean. As a further example, because a boundary layer of a fluid against the wall of a container can have a significant impact on heat transfer, even a small eddy current (e.g., about as small or smaller than the thickness of the boundary layer) can be effective if it disturbs the boundary layer. A further example of an eddy current is the movement of the liquid inside a container caused by vibrating and/or shaking of the wall of the container in response to a force or disturbance from outside the container, for example, a force or disturbance caused by a vibration generator as described herein. As illustrated, for example, in FIG. 8, movement of a portion of a wall 891 of a container C relative to a remainder of the wall 893 of the container (and relative to the contents of the container) can create eddy currents 895 in the contents 801 of the container.

As an example, the eddy currents can be especially useful for liquids in a container that have a lower viscosity or a viscosity similar to that of water. For example, the eddy currents can be especially useful to reduce temperature gradients in liquids up to 500, 100, 75, 50, 25, 10, 5, 2, 1 cPs at the temperature at which the eddy currents are induced and the heat transfer is conducted.

After the containers are heated or cooled to their desired temperature, each of the containers can be labeled at the labeler 125.

At the packaging machine, for example, the filled containers can be placed into cartons, and the cartons of containers can be placed on pallets. The pallets can also be wrapped with plastic sheeting for shipment to warehouses and can be subsequently shipped to customers.

Turning more specifically to the cooling/heating process itself, within the cooling/heating tunnel 120, various techniques for cooling or heating the containers and their contents can be deployed. In one example, fluids, such as liquid, or room temperature water, can be sprayed on or over the containers to heat or cool the beverages as they travel to the labeler 125. Other examples can include spraying the containers with chilled water, for example, in the range of 35-60° F. (1.67° C. to 15.56° C.) to cool the hot-filled beverage, spraying the containers with heated water, for example, in the range of 80-110° F. (26.67° C. to 43.33° C.) to heat the cold-filled beverages, or submerging the containers in temperature controlled water or other liquids to bring beverage temperature to desirable ranges for example. Other examples can include the application of air, CO₂ gas, or other gas types in a chamber or tunnel.

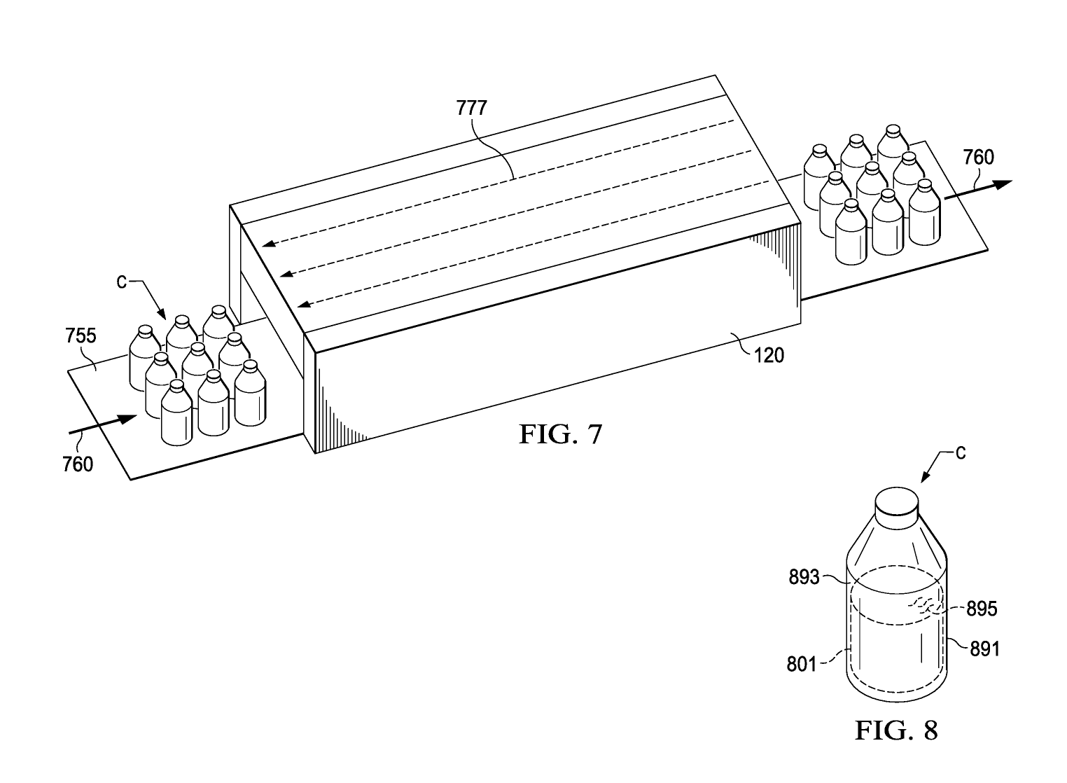

As illustrated in FIG. 7, a cooling/heating tunnel 120 is configured to generally surround containers C travelling in a direction of conveyance 760 on a conveyor (e.g., conveyor belt 755). As illustrated, gas 777 (e.g., air, etc.) is applied to containers in a counter-current flow configuration relative to the direction of conveyance 760 of the containers C. Although liquids, sprayers, submersion, vibration generators and other elements described herein are not expressly illustrated in the cooling/heating tunnel 120 shown in FIG. 7, after reading this disclosure, a skilled person would understand that such elements can be added to the cooling/heating tunnel 120. Similarly, illustrated elements can be omitted (for example the specific type of conveyor, cooling or heating medium or use of counter-current flow). Likewise, any element described herein can be substituted for another element shown in FIG. 7 or any other illustration, when the other element provides a similar function (e.g., conveyance, use as a cooling/heating medium, etc.).

In another example, either in addition to or alternatively, the cooler or heater can be a part of, or can extend the entire length of the conveyer belt. It is also contemplated that a combination of the above techniques could be utilized to cool or heat the contents of the containers. Additionally, although the term spray, sprayer and related terms are used herein, additional embodiments can be formed by replacing “spray” with “discharge,” “shower,” “stream,” or “jet” and by replacing, for example, “sprayer” with “discharger.” Furthermore, the term discharge can be generally used to refer to a spray, shower, stream, jet or other propelled fluid.

In some embodiments, the containers can be conveyed by any conveyor that is compatible with a heating or cooling fluid (e.g., liquid, water, etc.). For example, the conveyor can be configured to enable a liquid to flow through the conveyor. Additionally, a conveyor can be used that helps avoid the accumulation of a liquid, for example, so that containers do not float away from the conveyor in the accumulated liquid. In one example, the containers can be conveyed using a wire-mesh conveyer. In some examples, the conveyor can be a roller or a line or wire. In some embodiments, the conveyor can grip a container (e.g., neck of the container). A conveyor that grips the container can be advantageous if the container is to be submerged in a heating and/or cooling medium (e.g., liquid) in a reservoir, for example, to help prevent the container or some portion thereof from floating out of the heating and/or cooling medium. In certain examples, the conveyor/conveying device provides movement in only one dimension. For example, a wire-mesh conveyer can be used mainly for single direction movement when the containers are conveyed, and the cooling/heating relies solely on the cooling/heating medium without directly agitating the contents of the containers.

However, in conjunction with the techniques above for cooling or heating the contents of the containers, the heat transfer process can be increased. Again, reducing the temperature gradient of the liquid inside of a container, thus, increasing the temperature gradient between the media and the liquid interface can help to increase the heating or cooling of the containers and their contents. This can include the application of mechanical vibration, and/or oscillating and/or acoustic resonance directly to the containers and/or to the cooling or heating media of the containers, as described in further detail below. For example, mechanical vibration or acoustic resonance can be provided on either hot-filled or cold-filled processes to assist with cooling or heating the contents in the containers depending on the desired temperature of the next processing step. As an example of resonance, containers can be consistently exposed to a vibration-inducing force at a specific frequency that causes the containers to vibrate with increased or at least approximately constant amplitude at the specific frequency. After reading this disclosure, a skilled person would understand that due to the geometry of a container, forces applied to a container wall can cause vibration in a first portion of the wall of the container, shaking in second portion of the wall of the container, and both vibration and shaking in a third-portion of the wall of the container. Accordingly, any or some combination of these phenomena can occur over an entire container or a portion of a container. Likewise, it is possible that any or some combination of these phenomena do not occur at all in an entire container or portion of a container, depending, for example, on the geometry of the container and the vibrational generator being used.

Specifically, the changing momentum caused by the motion of the container contents or the heating/cooling media creates movement of the container shell, such as a PET plastic bottle body wall that in turns, creates agitation of the contents inside the container to assist with cooling or heating. For example, while the container is moving in the forward direction within the cooling/heating tunnel 120, the acoustic, oscillating, or intermittent or vibrational energy or a combination thereof introduced on or imparted to the containers disturbs the liquid to generate eddy currents and reduces temperature gradients in all directions from the center of container. In other words, the force exerted on the contents of the containers creates convection and increases the cooling or the heating of the contents in the containers.

As discussed in more detail in relation to the examples discussed below, the mechanisms to generate container content or media motions during the cooling or heating process can include, for example: (1) vibrating the conveyor (e.g., conveyor belt, line, wire, rollers, etc.), (2) pulsating centrally controlled or individually operated spray nozzles (e.g., by opening and closing the nozzle, changing the direction that the nozzle is aimed in an oscillating pattern, etc.), (3) shaking individually connected spray nozzles, (4) shaking a multiunit spraying bar or individual spray nozzles with one or more mechanical or electromagnetic shakers (5) providing an acoustic-resonance-equipped (e.g., subwoofer-equipped) heat transfer media reservoir or (6) any combinations of the above concepts. As an example of an acoustic-resonance-equipped heat transfer media reservoir (e.g., tank), containers could be passed through a tank filled with liquid, and an acoustic vibration generator (e.g., subwoofer) could be positioned and oriented so that acoustic energy from the vibration generator causes vibration of the contents of the containers. For example, the acoustic vibration generator could be mounted on a reservoir, in a reservoir, or underneath a reservoir to generate vibration of the contents of a container.

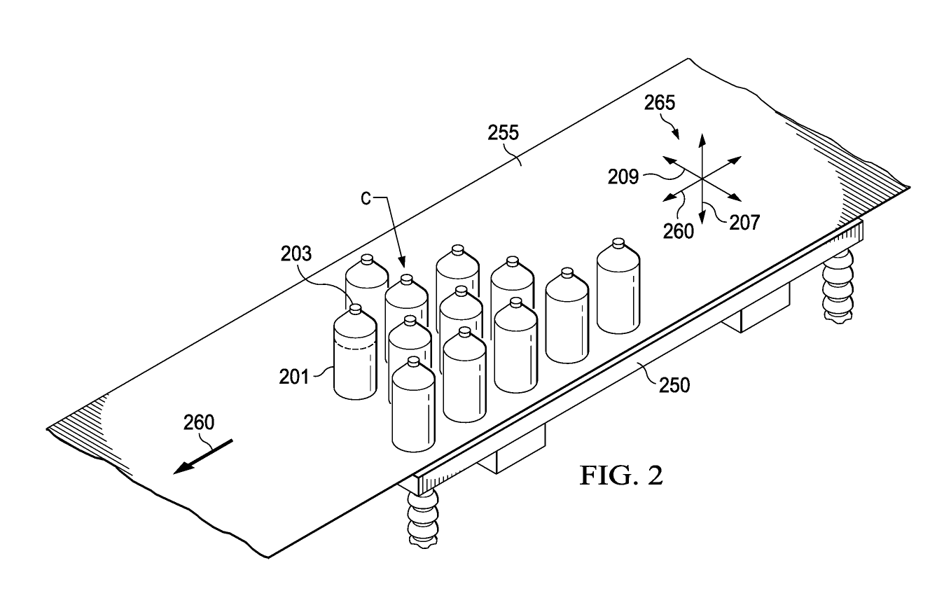

One embodiment of the invention will now be described with reference to FIG. 2, in which like reference numerals (e.g., in the last two digits) refer to the same or similar elements that can provide similar functions as discussed herein. FIG. 2 illustrates an example of an increased heat transfer method in which vibration can be directly applied to the containers C as they are conveyed through a cooling or heating process, for example, from the filling station to the labeling station in the direction of arrow 260. In this example, the agitation can be generated by incorporating a vibration generator 250, which can be located directly underneath the conveyor belt 255. The vibration generator 250 can be formed of any type and, in one example, can include one or more mechanical, electromagnetic, and/or acoustic devices and/or pneumatic devices to generate vibrations directly onto the conveyor (e.g., conveyor belt 255) to provide vibrations to the containers. These vibration generators can include but are not limited to electric motors with unbalanced masses, electromagnetic shakers, tactile transducers, subwoofers, and the like. As an example of an unbalanced mass, a rotating mass (e.g., cam) that is unevenly weighted across an axis of rotation would tend to cause wobbling, oscillation or vibration as the cam rotates. The vibration generator 250 applies forces to the conveyor (e.g., conveyor belt 255) and ultimately to the containers and the contents (e.g., fluid, beverage 201, etc.) of the containers in various directions, which are illustrated by the vectors 265. These forces also create movement of the fluid within the containers in the various directions illustrated by the vectors 265, as applicable. In other examples, the belt 255 can be formed of different sections, and each section can be vibrated by one or more vibration generators (e.g., mechanical and/or acoustic devices) as discussed herein.

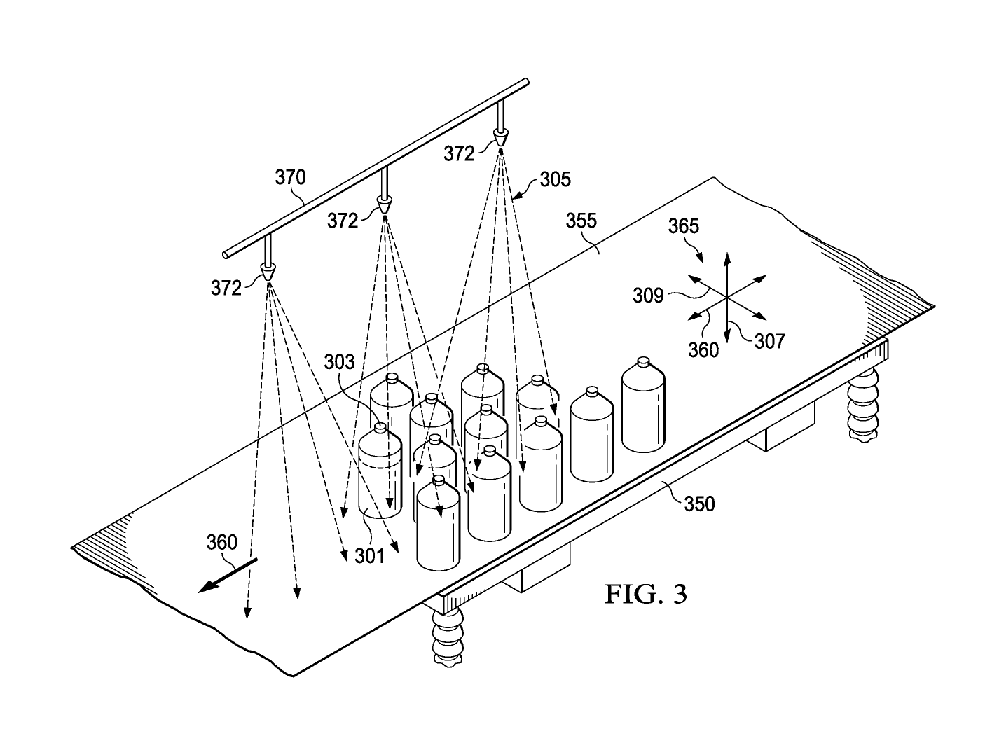

FIG. 3 shows another exemplary embodiment, in which like reference numerals (e.g., in the last two digits) refer to the same or similar elements that can provide similar functions as discussed herein. This example is similar to the example discussed in relation to FIG. 2. However in this example, either, separately or in addition to the vibration generator 350, the system can be provided with a sprayer 370 having one or more sprayer nozzles 372. As depicted schematically, the sprayer 370 and sprayer nozzles 372 can be configured to pulsate spraying a fluid 305 (e.g., in a gas form, liquid form, or a combination thereof) at the containers C. When a combination of fluids is used, they can, for example, be mixed and discharged from the same nozzle or they be discharged from separate nozzles. The sprayer nozzles 372 can be centrally controlled or can be pulsated individually. The spray from the sprayer nozzles 372 can both act as a cooling or heating medium while vibrating the contents of the containers C. Also different types of fluids and gases can be used to provide the desired cooling or heating effect. The pulsation of the spray nozzles 372 can act as a vibration generator and can induce heat transfer by agitating the contents of the containers C separately or in conjunction with the vibration generator 350.

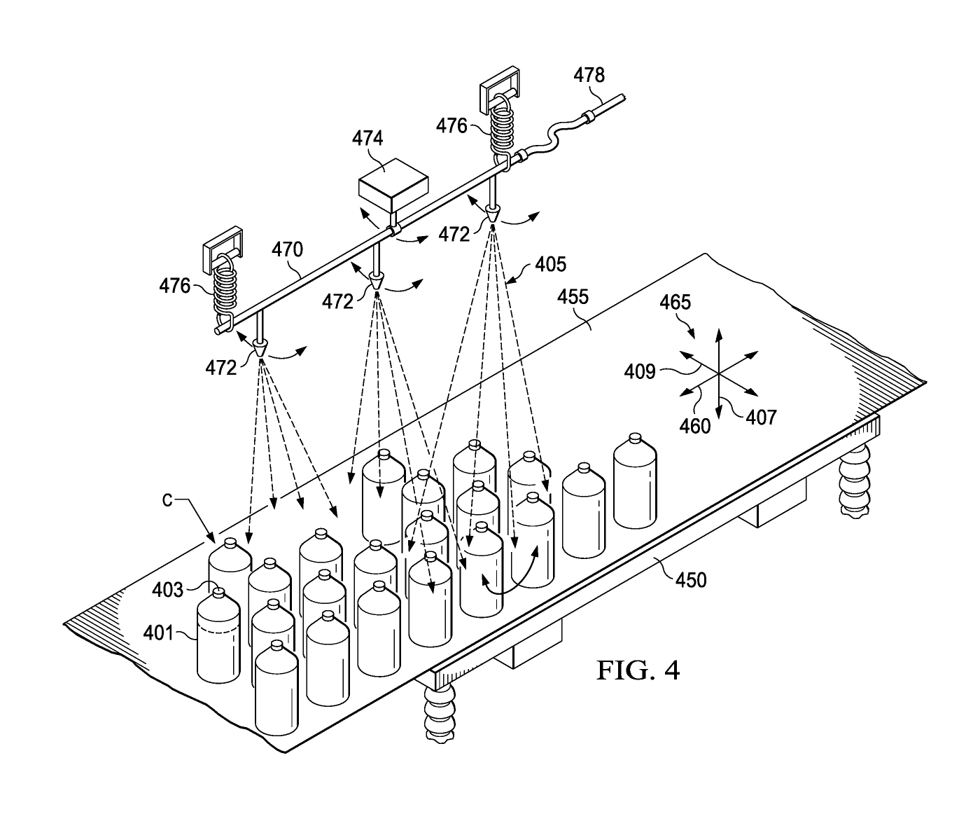

FIG. 4 shows yet another exemplary embodiment, in which like reference numerals (e.g., in the last two digits) refer to the same or similar elements that can provide similar functions as discussed herein. This example is similar to the example discussed in relation to FIGS. 2 and 3; however, in this example, as shown in FIG. 4, the cooling/heating tunnel can include a fluid sprayer 470 with a group of nozzles 472 attached to one or more vibration generators 474 (such as mechanical motors, electromagnetic motors, or pneumatic devices), and/or springs 476 to vibrate/oscillate the sprayer 470 and the nozzles 472. This causes the fluid spray emitted from the nozzles 472 to oscillate thereby also causing contents of the containers to oscillate to promote the heating or cooling of the contents of the containers by disruption to generate eddy currents and reducing temperature gradients in all directions from the centers of the containers C as the containers travel through the system, for example, from the capper to the labeler. Like in the above examples, the fluid sprayer 470 provides/sprays fluid 405 onto the containers, which depending on the temperature of the fluid 405, to also cause the contents of the containers to either cool or warm.

In addition or alternatively, the nozzles 472 of the fluid sprayer 470 can be mounted to a single shaft 478, and the one or more vibration generators 474 can be configured to oscillate the shaft 478 by rotation or by shifting the shaft back and forth in essentially any direction or combination of directions, for example, vertically (up and down or parallel to a direction of gravitation acceleration 407), horizontally (in a plane perpendicular to the direction of gravitational acceleration), longitudinally (along the length of a conveyor in the direction of conveyance 460 at any point along the conveyor) or laterally (in a lateral direction perpendicular to the direction of conveyance at any point along the length of the conveyor), or any combination thereof. This causes the spray from the nozzles to be in constant movement over the containers, thereby causing the contents of the containers to become agitated, thus inducing heat transfer as discussed herein. It is also contemplated that in this example, the spray from the nozzles 472 could be pulsated, in accordance with the above example, to induce additional agitation of the contents of the containers C.

Alternatively, several vibration generators could be used where each of the vibration generators can be individually or separately connected to individual spray nozzles, such that the vibration of each of the spray nozzles is controlled individually. In another alternative embodiment, one or more vibration generators can be connected to a multiunit spraying bar or manifold (e.g., sprayer 470 in FIG. 4). The spraying bar could include several ports or outlets for the spraying fluid, and the one or more vibration generators could provide the requisite vibration and/or resonance to the spraying bar to assist in increasing the heat transfer rate.

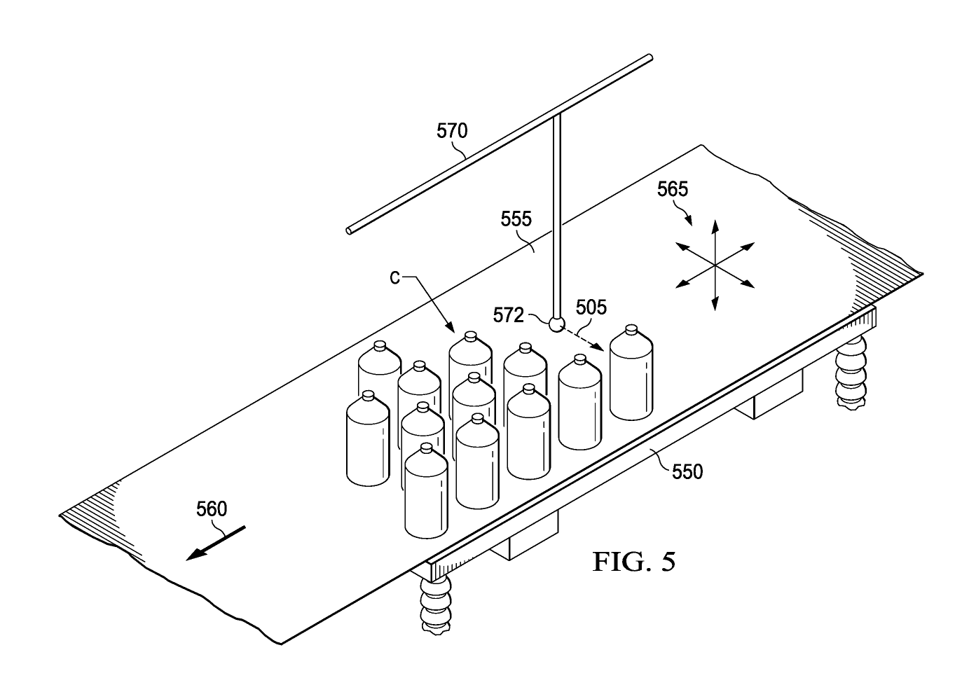

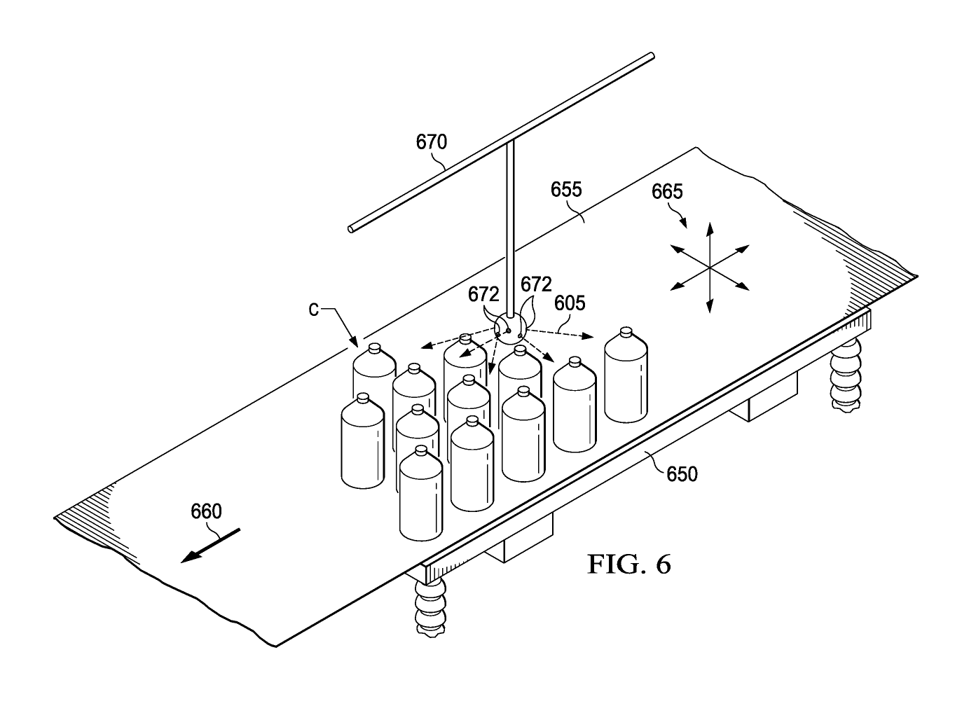

Furthermore, with reference to FIG. 5 and FIG. 6, a nozzle 572 or nozzles 672 can have a 360 degree range of position and/or orientation or a range of position and/or orientation that covers essentially all directions, for example, by providing a nozzle 572 with a ball socket or by fixing multiple nozzles 672 in a pattern approximating a sphere or some portion thereof (e.g., mounting the nozzles to the surface of a spherical shaped support as illustrated in FIG. 6). As with the other Figures, FIG. 5 and FIG. 6 illustrate exemplary embodiments in which like reference numerals (e.g., in the last two digits) refer to the same or similar elements that can provide similar functions as discussed herein. The range of position and/or orientation illustrated in FIGS. 5 and 6 can be useful so that a nozzle or nozzles can be configured to discharge a fluid 505, 605 at a container or containers from among the containers, below the containers, adjacent to the containers, or above the containers, thereby providing fluid from different angles relative to the direction of gravitational acceleration and/or conveyance of the containers. This can be useful, for example, to provide better heat transfer to a container. In these or other embodiments, the nozzles and/or the structure which supports the nozzles can be configured to adjust the position and/or orientation of the nozzle relative to a conveyor 655 and/or container C. As shown in FIG. 5, a single nozzle can be positioned and oriented to generate vibration in a container or containers, for example, by changing position and/or orientation of the nozzle, changing the velocity of the fluid exiting the nozzle, or turning the flow of a fluid on and off. Similarly, with reference to FIG. 6, a plurality of nozzles can be positioned and oriented to generate vibration in a container or containers, for example, by changing position and/or orientation of a nozzle or nozzles, changing the velocity of the fluid exiting a nozzle or nozzles, or turning the flow of a fluid on and off for a nozzle or nozzles. Additionally, a plurality of nozzles can be arranged in a grid pattern to discharge a greater density of fluid in a specific volume or over a specific area encompassing a container or containers and to discharge the fluid from a plurality of angles toward a container or containers, for example, to provide better heat transfer from the fluid to a container. For example, this can be accomplished by placing several shafts 478 (e.g., with associated nozzles 472 as illustrated in FIG. 4) substantially adjacent and/or parallel to each other above one or more of the containers and/or a conveyor 455.

Generally in accordance with the above examples pertaining to the use of spraying fluids to generate force to cause beverage movement inside of the container, the momentum created by the fluids can be calculated by the physic law, momentum p=mv, where m is the mass and v is the velocity or force F=m Δv/Δt. In this way, the flow rate and nozzle size can then be designed to achieve the best heat transfer results. For example, without wishing to be bound by theory, a fluid with a specified momentum can impact the wall of a container to impart a specific momentum or force to the wall and to move or deform the wall. This movement or deformation of the wall can, in turn, displace fluid in the container causing turbulence (e.g., in the form of waves or eddies) in the fluid in the container. This turbulence helps decrease the thickness of a fairly stagnant boundary layer of fluid just inside the wall of the container and helps decrease the temperature gradient within the fluid from wall of the container to the center of the container, which results in increased heat transfer between the fluid in the container and the cooling or heating media. Moreover, the cooling or heating media can be a single fluid type or can be different fluids. In addition, the cooling or heating media can also be in a liquid or gas phase or a combination of the two.

As discussed herein, alternatively or in conjunction with the examples discussed above, acoustic devices can provide a desirable frequency for increasing the heat transfer rate depending on the particular containers being filled with product. Different sized containers can require different frequencies to provide for the requisite amount of vibration for aiding in cooling or heating the contents of the containers. The frequency range and amplifier can be selected in order to ensure that the contents of the containers are properly agitated to provide increased heat transfer. In one example, the acoustic device can be an audio speaker, such as a tactile transducer or subwoofer setting at, for example, 35-60 Hz. Other frequency ranges are also contemplated; however, too low or too high a frequency can, in certain instances, fail to cause resonance and fail to agitate the content of the containers enough to help induce heat transfer. As additional examples, the vibration can be provided at a frequency of 1-40, 1-10, 10-20, 20-30, 30-40, 10-30, or 15-25 Hz, for example, when a fluid (e.g., liquid, water, etc.) is used to provide vibration to a container. Moreover, the vibration can be provided at a frequency of 20-70, 20-30, 30-40, 40-50, 50-60, 60-70, 30-60, or 40-50 Hz, for example, when an acoustic device (e.g., subwoofer, speaker, tactile transducer, etc.) is used to provide vibration to a container. It should be understood that when a range for a particular variable is given for an embodiment, an additional embodiment can be created using a subrange or individual values that are contained within the range. Moreover, when a value, values, a range, or ranges for a particular variable are given for one or more embodiments, an additional embodiment can be created by forming a new range whose endpoints are selected from any expressly listed value, any value between expressly listed values, and any value contained in a listed range. For example, for an embodiment in which a variable is 1-40 Hz and a second embodiment in which the variable is 20-70 Hz, a third embodiment can be created in which the variable is 40-55 Hz. Similarly, a fourth embodiment can be created in which the variable is 10-50 Hz. For example, in light of the present disclosure, a skilled person would be able to provide a selected degree of vibration and use the vibration to increase the rate of heat transfer between a heating or cooling medium and a container and its contents.

By deploying the techniques discussed herein, test results indicate that the overall heat transfer rate can be relatively improved. In one example test, a subwoofer was implemented to generate resonance on containers after a hot filling operation. Specifically, each test container was placed on a wooden plate with a subwoofer mounted underneath. After the containers were filled with the hot beverage, cooling was performed with a water sprinkling system directed at the top of the containers from three separate nozzles. Control data was collected with no agitation, and data was collected with agitation by affixing resistance temperature detector (“RTD”) probes within the liquid at approximately the geometric centers of the containers or the centers of gravity of the containers. The RTD probes can extend through the neck of the container or the closure or cap toward the center of the containers and are configured to send analog signals to a computer for recording the temperature changes. The subwoofer was operated at 50 Hz, 0.81 A, 4.5V, the spray water flow rate was 0.75 gallons per minute (2.839 liters per minute) at approximately 50.6° F. (10.33° C.), and the ambient temperature was 79.4° F. (26.33° C.) during the testing. The results of this testing appear in Table 1 below.

TABLE 1
VIBRATION ENHANCED COOLING TEST

| | 165-140° F. | 140-120° F. | 120-100° F. |
|---|---|---|---|
| | (73.89-60.00° C.) | (60.00-48.89° C.) | (48.89-37.78° C.) |
| Trial | degree/sec | degree/sec | degree/sec |
| Control 1 | 0.342 | 0.263 | 0.190 |
| Test 1 | 0.325 | 0.294 | 0.183 |
| Control 2 | 0.291 | 0.220 | 0.187 |
| Test 2 | 0.325 | 0.256 | 0.177 |
| Control 3 | 0.333 | 0.247 | 0.175 |
| Test 3 | 0.373 | 0.274 | 0.189 |
| Control 4 | 0.325 | 0.244 | 0.168 |
| Test 4 | 0.333 | 0.260 | 0.182 |
| Control 5 | 0.325 | 0.244 | 0.169 |
| Test 5 | 0.325 | 0.260 | 0.168 |
| Control | 0.323 | 0.244 | 0.178 |
| Average | | | |
| Test Average | 0.336 | 0.269 | 0.180 |
| Test/Control | 104.00% | 110.37% | 100.97% |

As summarized in Table 1, temperature and time were recorded for each container (e.g., Test 1-5 and Control 1-5) as each container was cooled from 165° F. to 100° F. (73.89-37.78° C.). Furthermore, the average decrease in degrees per second were calculated for each bottle over set temperature intervals from 165 to 140° F. (73.89-60.00° C.), from 140 to 120° F. (60.00-48.89° C.), and then from 120 to 100° F. (48.89-37.78° C.). According to the data above, the heat transfer rate of the containers increased by 2 to 10%, with an average of 5%, depending on the particular temperature range. However, it has been observed that the heat transfer rate can increase by 10% or more. The heat transfer properties improved the most in the 140° F.-120° F. (60.00-48.89° C.) range and the least amount in the 120° F.-100° F. (48.89-37.78° C.) range. Although, over some temperature intervals, it appeared that the control container (without agitation) performed better than the test container (with agitation), it is believed this occurred due to difficulty in measuring the temperature at the precise center of a vibrating container and due to some variations in cooling water temperature between the control and test group. Furthermore, the experimental data illustrated in Table shows average better heat transfer performance using vibration enhanced cooling for every temperature range, as noted at the bottom of Table 1. Also, while the results presented in Table 1 involved cooling (e.g., a container) and the use of an acoustic vibration generator, the underlying principles for increasing heat transfer are also applicable to heating and/or other types of vibration generators, for example, as described herein.

Utilizing the methods disclosed herein can help to shorten the amount of heat transfer time. Shorter heating and cooling times can also help to reduce the amount of resources, space, and equipment required within a manufacturing facility. For example, water for cooling or heating the containers can be reduced as the heat transfer process becomes more efficient. Chemical usage can be reduced as the equipment can be smaller. It follows that the labor and time for cleaning the equipment can be reduced. The electricity used to run the process can also be reduced in requiring less amounts of water to cool or heat the containers. The space of the manufacturing facility can also be reduced as the equipment can fit into a smaller space with a reduced sized cooling/heating tunnel.

An example method for producing a beverage can include mixing ingredients for forming the beverage, filling a plurality of containers with the beverage, capping each of the containers with an enclosure 203, agitating the contents of the containers to mix the beverage in the containers to create movement of the beverage within the containers and to generate eddy currents, reducing temperature gradients in the containers to increase a heat transfer rate of the beverage in the containers while simultaneously cooling or heating the contents of the containers in a tunnel and while simultaneously transporting the containers through the tunnel, and labeling each of the containers. The heat transfer rate can be increased by 2% to 10% and, in certain instances, can be increased by more than 10%.

As an example, the heat transfer rate can be increased by 2% to 10% or more than 10% relative to a control heat transfer rate for a control method that is identical, essentially identical, or substantially identical to the method of this claim except that the control method does not comprise agitating the liquid product of the containers to mix the liquid product in the containers to create movement of the liquid product within the containers and to generate eddy currents, reducing a temperature gradient (or temperature gradients) in the liquid product to increase a heat transfer rate of the liquid product in the containers.

It is worthwhile to note that depending on the method, the control method could be identical, essentially identical, or substantially identical to the method of this invention, except that a vibration generator is not used. If, for example, the vibration generator is an acoustic device or vibrating conveyor, a fairly straightforward comparison can be obtained by turning off the acoustic device or the vibrations for the vibrating conveyor.

On the other hand, if the vibration generator is a pulsating fluid (e.g., the heating or cooling medium) the comparison can be a little more nuanced. For example, the control method can have the same time-weighted average flow rate of the heating or cooling medium as the method of this invention so that the control method and the method of this invention have substantially the same mass flow rate of the heating or cooling medium in contact with the container or containers being tested. As a skilled person would understand, both methods can have the same time-weighted average flow rate without having the same instantaneous flow rate.

For example, if the method of this invention uses a pulsating fluid for a heating or cooling medium and the pulsating fluid is on for half of the operating time and off for half of the operating time, then the instantaneous flow rate would oscillate between nothing and some higher value, and the average flow rate would be half the higher value. Accordingly, in order for the control method and the method of the invention to be identical, essentially identical, or substantially identical, except that a vibration generator is not used in the control method, both the control method and the method of the invention could use the same average flow rate of a heating or cooling medium, but the control method would not include pulsating the heating or cooling medium.

Agitating the contents of the containers can include applying acoustic energy to the containers while transporting the containers to the labeler, and applying acoustic energy can include subjecting the containers to a tactile transducer. Additionally, agitating the contents of the containers can include applying or imparting vibrational energy to the containers while transporting the containers to the labeler. Also the agitating the contents of the containers can include both applying acoustic energy and applying or imparting vibrational energy to the containers while transporting the containers to the labeler. Filling the plurality of containers with the beverage can also include heating the beverage to a higher temperature to assist in sterilizing the beverage.

Moreover, the vibrational energy can be applied or imparted to the containers by spraying the containers with a fluid. In one example, the fluid can be pulsated during spraying the containers with the fluid. Moreover, the fluid can be a combination of a gas and a liquid. The fluid can also cool or heat the beverage in the containers.

In one example, after capping the containers with an enclosure, the containers can be transported through the tunnel by a conveyor belt, and the conveyor belt can include a vibration generator. Also filling the plurality of containers with the beverage can include a hot-fill or a cold-fill process.

Another example method for accelerating a heat transfer rate of a beverage in a container can include directing fluid at the container and contacting the container with the fluid to agitate the contents of the container to mix the beverage in the container to create movement of the beverage within the container and to generate eddy currents in the beverage, reducing temperature gradients in the beverage to increase a heat transfer rate of the beverage in the container and simultaneously cooling or heating the beverage of the container with the fluid directed at the container. The method can also include applying acoustic energy to the containers while transporting the container or both applying acoustic energy and applying or imparting vibrational energy to the containers while transporting the containers to the labeler. The fluid can be pulsated during spraying the containers with the fluid. Moreover, the fluid can be a combination of a gas and a liquid. The heat transfer rate can be increased by 2% to 10% in employing these techniques and, in certain instances, can be increased by more than 10%.

An example apparatus can include a conveyor belt for transporting containers, a cooling or heating medium, a vibration generator configured to agitate contents of the containers to mix the contents in the containers to create movement of the contents within the containers and to generate eddy currents in the contents, reducing temperature gradients in the container to increase a heat transfer rate of the contents in the containers. In one example, the vibration generator can be configured to apply vibrations to the conveyor belt. In another example, the vibration generator can be a spray applied by at least one nozzle, and the spray can be pulsated. Then at least one nozzle can be mounted to a motor and the motor can be configured to vibrate the nozzle while the nozzle dispenses the spray. The vibration generator can be an acoustic transducer.

This disclosure is not limited to the disclosed embodiments. To the contrary, the present disclosure is intended to cover various modifications and equivalent arrangements.

### Additional Embodiments

The following clauses are offered as further description of the disclosed invention:
1. A method for producing a liquid product (e.g., comestible, liquid food product, soup with or without solid particles such as grains or meat, beverage, etc.) comprising:
   optionally, mixing ingredients for forming the liquid product;
   filling a plurality of containers with the liquid product;
   capping each of the containers with an enclosure;
   agitating the liquid product of the containers to mix the liquid product in the containers to create movement of the liquid product within the containers and to generate eddy currents (e.g., micro eddy currents), reducing a temperature gradient (or temperature gradients) in the liquid product to increase a heat transfer rate of the liquid product in the containers, while simultaneously cooling or heating the liquid product of the containers and, optionally, while simultaneously transporting the containers; and
   optionally, labeling each of the containers using a labeler.
2. The method of clause 1 wherein agitating the contents of the containers comprises applying acoustic energy to the containers, optionally, while transporting the containers, further optionally, to the labeler.
3. The method of clause 2 wherein applying acoustic energy comprises subjecting the containers to a tactile transducer.
4. The method of any previous clause wherein agitating the contents of the containers comprises imparting or applying vibrational energy to the containers, optionally, while transporting the containers, further optionally, to the labeler.
5. The method of any previous clause wherein agitating the contents of the containers includes both applying acoustic energy and imparting or applying vibrational energy to the containers, optionally, while transporting the containers, further optionally, to the labeler.
6. The method of any previous clause wherein filing the plurality of containers with the liquid product further comprises heating the liquid product to a higher temperature to assist in sterilizing the liquid product.
7. The method of clause 4 or 5 wherein the vibrational energy is imparted or applied by contacting (e.g., spraying, showering) the containers with a fluid.
8. The method of clause 7 wherein the fluid is pulsated during contacting (e.g., spraying, showering) the containers with the fluid.
9. The method of clause 7 or 8 wherein the fluid comprises a combination of a gas and a liquid.
10. The method of any of clauses 7-9 wherein the fluid also cools or heats the liquid product in the containers (e.g., wherein the fluid substantially cools or heats the liquid product or acts as a primary heating or cooling medium for cooling or heating the liquid product).
11. The method of any previous clause wherein after capping the containers with an enclosure, the containers are transported through a tunnel by a conveyor (e.g., conveyor belt, rollers, line) and wherein the conveyor comprises a vibration generator.
12. The method of any previous clause wherein filling the plurality of containers with the liquid product comprises a cold-fill process (e.g., wherein the containers are filled with the liquid product when the liquid is at less than 175° F. (79.44° C.), from above 32° F. to 160° F. (0.00° C. to 71.11° C.), or between 32° F. and 175° F. (0.00° C. and 79.44° C.).
13. The method of any previous clause wherein the heat transfer rate is increased by 2% to 10% relative to a control heat transfer rate for a control method that is identical or substantially identical to the method of this claim except that the control method does not comprise agitating the liquid product of the containers to mix the liquid product in the containers to create movement of the liquid product within the containers and to generate eddy currents, reducing a temperature gradient (or temperature gradients) in the liquid product to increase a heat transfer rate of the liquid product in the containers.
14. The method of any of clauses 1-12 wherein the heat transfer rate is increased by more than 10% relative to a control heat transfer rate for a control method that is identical or substantially identical to the method of this claim except that the control method does not comprise agitating the liquid product of the containers to mix the liquid product in the containers to create movement of the liquid product within the containers and to generate eddy currents, reducing a temperature gradient (or temperature gradients) in the liquid product to increase a heat transfer rate of the liquid product in the containers.
15. A method comprising:
   causing movement in a portion of a wall of a container relative to a remainder of the wall of the container (e.g., imparting vibrational energy to a wall of a container, or directing fluid at a container and contacting the container with the fluid) to agitate contents of the container to mix the contents in the container to create movement of the contents within the container and to generate eddy currents (e.g., micro eddy currents) in the contents, reducing a temperature gradient (or temperature gradients) in the container to increase a heat transfer rate of the contents in the container; and
   simultaneously cooling or heating the contents of the container, optionally, with the fluid directed at the container.
16. The method of any previous clause further comprising applying acoustic energy to the container (e.g., the cause the movement in the portion of the wall of the container to agitate the contents in the container), optionally, while transporting the container and/or directing fluid at a container and contacting the container with the fluid to agitate the contents in the container).
17. The method of clause 15 or 16 wherein the fluid is pulsated during contacting (e.g., spraying, showering) the container with the fluid.
18. The method of any of clauses 15-17 wherein the fluid comprises a combination of a gas and a liquid.
19. The method of any of clauses 15-18 wherein the heat transfer rate is increased by 2% to 10% relative to a control heat transfer rate for a control method that is identical or substantially identical to the method of this claim except that the control method does not comprise agitating the contents of the container to mix the contents in the container to create movement of the contents within the container and to generate eddy currents in the contents, reducing a temperature gradient (or temperature gradients) in the container to increase a heat transfer rate of the contents in the container.
20. The method of any of clauses 15-18 wherein the heat transfer rate is increased by more than 10% relative to a control heat transfer rate for a control method that is identical or substantially identical to the method of this claim except that the control method does not comprise agitating the contents of the container to mix the contents in the container to create movement of the contents within the container and to generate eddy currents in the contents, reducing a temperature gradient (or temperature gradients) in the container to increase a heat transfer rate of the contents in the container.
21. An apparatus comprising:
   a cooling or heating medium (e.g., fluid);
   a vibration generator configured to agitate contents of a container (or containers) to mix the contents in the container (or containers) to create movement of the contents within the container (or containers) and to generate eddy currents (e.g., micro eddy currents) in the contents, reducing a temperature gradient (or temperature gradients) in the contents of the container (or containers) to increase a heat transfer rate of the contents in the container (or containers) while the cooling or heating medium is applied to the container (or containers); and
   optionally, a conveyor (e.g., conveyor belt, rollers, line) for transporting the container or containers.
22. The apparatus of clause 21 wherein the vibration generator is configured to apply vibrations to the conveyor.
23. The apparatus of clause 21 wherein the vibration generator is a fluid (e.g., liquid, gas, discharge, spray, shower, stream, jet, or a combination thereof) applied by at least one nozzle.
24. The apparatus of clause 23 wherein the fluid is pulsated.
25. The apparatus of clause 23 or 24 wherein the fluid is the cooling or heating medium.
26. The apparatus of any of clauses 23-25 wherein the at least one nozzle is mounted to a motor and wherein the motor is configured to vibrate the nozzle while the nozzle dispenses the fluid.
27. The apparatus of clause 21 wherein the vibration generator is an acoustic transducer.
28. The apparatus of clause 21, wherein the apparatus comprises at least one vibration generator, wherein the at least one vibration generator is selected from the following: a vibration generator configured to apply vibrations to the conveyor; a vibration generator that is a fluid (e.g., liquid, gas, discharge, spray, shower, stream, jet, or a combination thereof) applied by at least one nozzle; a vibration generator that is an acoustic transducer; or any combination thereof.
29. The method or apparatus of any previous claim wherein the liquid product or the contents in the container (or containers) has a viscosity during agitating and simultaneous cooling or heating, wherein the viscosity is selected from the viscosities consisting of: no more than 500, 100, 75, 50, 25, 10, 5, 2, and 1 cPs.

Although embodiments of the invention have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments. For example, it should be understood that the method steps described herein are exemplary, and upon reading the present disclosure, a skilled person would understand that one or more method steps described herein can be combined, omitted, re-ordered, or substituted.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for producing a liquid product comprising:
filling a plurality of containers with the liquid product;
capping each of the containers with an enclosure; and
agitating the liquid product of the containers to mix the liquid product in the containers to create movement of the liquid product within the containers and to generate eddy currents, reducing a temperature gradient in the liquid product to increase a heat transfer rate of the liquid product in the containers, while simultaneously cooling or heating the liquid product of the containers.

2. The method of claim 1, further comprising:
simultaneously transporting the containers while agitating and cooling or heating the liquid product of the containers.

3. The method of claim 1, further comprising:
mixing ingredients for forming the liquid product.

4. The method of claim 1 wherein the agitating that occurs is in addition to any agitating that naturally occurs due to transporting the containers.

5. The method of claim 1 wherein the agitating causes movement in a portion of the wall of the container relative to the rest of the wall of the container, reversible deformation of a wall of the container, or vibration of a wall of the container.

6. The method of claim 1, further comprising:
labeling each of the containers using a labeler.

7. The method of claim 2, wherein the transporting the containers comprises transporting the containers to a labeler.

8. The method of claim 1 wherein agitating the contents of the containers comprises applying acoustic energy to the containers.

9. The method of claim 8 wherein applying acoustic energy comprises subjecting the containers to a tactile transducer.

10. The method of claim 1 wherein agitating the contents of the containers comprises imparting vibrational energy to the containers.

11. The method of claim 1 wherein agitating the contents of the containers includes both applying acoustic energy and imparting vibrational energy to the containers.

12. The method of claim 1 wherein filing the plurality of containers with the liquid product further comprises heating the liquid product to a higher temperature to assist in sterilizing the liquid product.

13. The method of claim 10 wherein the vibrational energy is imparted by contacting the containers with a fluid.

14. The method of claim 13 wherein the fluid is pulsated during contacting the containers with the fluid.

15. The method of claim 13 wherein the fluid comprises a combination of a gas and a liquid.

16. The method of claim 13 wherein the fluid also cools or heats the liquid product in the containers.

17. The method of claim 1 wherein after capping the containers with an enclosure, the containers are transported through a tunnel by a conveyor and wherein the conveyor comprises a vibration generator.

18. The method of claim 1 wherein filling the plurality of containers with the liquid product comprises a cold-fill process.

19. The method of claim 1 wherein the heat transfer rate is increased by 2% to 10% relative to a control heat transfer rate for a control method that is substantially identical to the method of this claim except that the control method does not comprise agitating the liquid product of the containers to mix the liquid product in the containers to create movement of the liquid product within the containers and to generate eddy currents, reducing a temperature gradient in the liquid product to increase a heat transfer rate of the liquid product in the containers.

20. The method of claim 1 wherein the heat transfer rate is increased by more than 10% relative to a control heat transfer rate for a control method that is substantially identical to the method of this claim except that the control method does not comprise agitating the liquid product of the containers to mix the liquid product in the containers to create movement of the liquid product within the containers and to generate eddy currents, reducing a temperature gradient in the liquid product to increase a heat transfer rate of the liquid product in the containers.

21. The method of claim 1 wherein the liquid product has a viscosity during agitating and simultaneous cooling or heating, wherein the viscosity is selected from the viscosities consisting of: no more than 500, 100, 75, 50, 25, 10, 5, 2, and 1 cPs.

22. The method of claim 1 wherein the liquid product is selected from: a beverage and a soup.

23. A method comprising:
causing movement in a portion of a wall of a container relative to a remainder of the wall of the container to agitate contents of the container to mix the contents in the container to create movement of the contents within the container and to generate eddy currents in the contents, reducing a temperature gradient in the container to increase a heat transfer rate of the contents in the container; and
simultaneously cooling or heating the contents of the container.

24. The method of claim 23, wherein the causing movement in the portion of the wall of the container comprises imparting vibrational energy to the wall of the container.

25. The method of claim 23, wherein the causing movement in the portion of the wall of the container comprises directing fluid at the container and contacting the container with the fluid.

26. The method of claim 25, wherein the simultaneously cooling or heating comprises simultaneously cooling or heating the contents of the container with the fluid directed at the container.

27. The method of claim 23 wherein the causing movement in the portion of the wall of the container comprises applying acoustic energy to the container.

28. The method of claim 25 wherein the fluid is pulsated during contacting the container with the fluid.

29. The method of claim 25 wherein the fluid comprises a combination of a gas and a liquid.

30. The method of claim 23 wherein the heat transfer rate is increased by 2% to 10% relative to a control heat transfer rate for a control method that is identical to the method of this claim except that the control method does not comprise agitating the contents of the container to mix the contents in the container to create movement of the contents within the container and to generate eddy currents in the contents, reducing a temperature gradient in the container to increase a heat transfer rate of the contents in the container.

31. The method of claim 23 wherein the heat transfer rate is increased by more than 10% relative to a control heat transfer rate for a control method that is identical to the method of this claim except that the control method does not comprise agitating the contents of the container to mix the contents in the container to create movement of the contents within the container and to generate eddy currents in the contents, reducing a temperature gradient in the container to increase a heat transfer rate of the contents in the container.

32. The method of claim 23 wherein the contents have a viscosity during agitation and simultaneous cooling or heating, wherein the viscosity is selected from the viscosities consisting of: no more than 500, 100, 75, 50, 25, 10, 5, 2, and 1 cPs.

33. The method of claim 23 wherein the causing movement in the portion of the wall of the container occurs while transporting the container.

34. An apparatus comprising:
a cooling or heating medium;
a vibration generator configured to agitate contents of a container to mix the contents in the container to create movement of the contents within the container and to generate eddy currents in the contents, reducing a temperature gradient in the contents of the container to increase a heat transfer rate of the contents in the container while the cooling or heating medium is applied to the container.

35. The apparatus of claim 21 further comprising:
a conveyor for transporting the container.

36. The apparatus of claim 35 wherein the vibration generator is configured to apply vibrations to the conveyor.

37. The apparatus of claim 34 wherein the vibration generator is a fluid applied by at least one nozzle.

38. The apparatus of claim 37 wherein the fluid is pulsated.

39. The apparatus of claim 37 wherein the fluid is the cooling or heating medium.

40. The apparatus of claim 37 wherein the at least one nozzle is mounted to a motor and wherein the motor is configured to vibrate the nozzle while the nozzle dispenses the fluid.

41. The apparatus of claim 34 wherein the vibration generator is an acoustic transducer.
